(19) United States
(12) Patent Application Publication
(10) Pub. No.: US 2025/0131860 A1
(43) Pub. Date: Apr. 24, 2025

(54) METHOD FOR CONTROLLING EXTENDED REALITY CONTENT DISPLAY, DEVICE, ELECTRONIC EQUIPMENT, AND STORAGE MEDIUM

(71) Applicant: Falcon Innovations Technology (Shenzhen) Co., Ltd., Shenzhen (CN)

(72) Inventors: Chenxi JI, Shenzhen (CN); Jieming ZHANG, Shenzhen (CN)

(73) Assignee: Falcon Innovations Technology (Shenzhen) Co., Ltd., Shenzhen (CN)

(21) Appl. No.: 19/002,432

(22) Filed: Dec. 26, 2024

(30) Foreign Application Priority Data
Aug. 1, 2024 (CN) 202411050285.X

(51) Int. Cl. G09G 3/00; G06V 20/20

(52) U.S. Cl. CPC G09G 3/001; G06V 20/20; G09G 2320/0613; G09G 2320/08; G09G 2340/0464; G09G 2340/14

(57) ABSTRACT

A method for controlling extended reality content display, applied to an extended reality device includes obtaining a display state information of the extended reality device, wherein the display state information indicates a display state of the extended reality device, if the display state of the extended reality device represents that an information display condition is satisfied, obtaining an information to be displayed, and controlling an optical display module of the extended reality device to display an extended reality content corresponding to the information to be displayed.

### CROSS-REFERENCE TO RELATED APPLICATIONS

This application claims priority to Chinese Patent Applications No. 202411050285.X, filed on Aug. 1, 2024 and entitled “METHOD FOR CONTROLLING EXTENDED REALITY CONTENT DISPLAY, DEVICE, ELECTRONIC EQUIPMENT, AND STORAGE MEDIUM”. The entire disclosures of the above application are incorporated herein by reference.

### TECHNICAL FIELD

Embodiments of this application relate to the field of extended reality, and more particularly to a method for controlling an extended reality content display, a device, an electronic equipment, and a storage medium, wherein the storage medium includes a computer-readable storage medium.

### BACKGROUND TECHNOLOGY

Extended Reality (XR) is a comprehensive term that encompasses Virtual Reality (VR), Augmented Reality (AR), and Mixed Reality (MR). XR technology extends human perception and interaction by integrating digital technologies with the real world, creating virtual, augmented, and mixed reality experiences. Similar to VR and MR, AR is a subset of XR. As used herein, XR and AR systems are described and referenced interchangeably. Unless stated otherwise, the descriptions herein apply equally to all types of mixed-reality systems, which (as detailed above) include AR systems, VR systems, and/or any other similar systems capable of displaying virtual objects.

XR provides a more intuitive and convenient content presentation experience through virtual reality scenarios. It is rapidly developing in fields such as entertainment, gaming, education, healthcare, enterprise production, and social communication, demonstrating immense potential and impact.

However, the current content presentation in virtual reality scenarios is still largely unrestrained, random, and unstructured. Once the device is powered on, XR content is displayed indiscriminately within the virtual reality scene. Additionally, when content to be displayed is detected, it is also presented without constraints. This approach can lead to excessive content being displayed or irrelevant content that users may find unengaging, thereby diverting attention from important content. While some systems utilize switch-based control interfaces to manage content display, such methods make content presentation control operations more complex, leaving room for improvement in user experience.

### SUMMARY OF INVENTION

Embodiments of this application provide a method for controlling an extended reality content display, a device, an electronic equipment, and a computer-readable storage medium. This solution accurately manages timing of content display, enabling an automatic control of an extended reality content presentation and enhancing a user experience.

In a first aspect, embodiments of this application provide a method for controlling an extended reality content display, applicable to an extended reality device. The method includes obtaining a display state information of the extended reality device, wherein the display state information indicates a display state of the extended reality device, if the display state of the extended reality device represents that an information display condition is satisfied, obtaining an information to be displayed, and controlling an optical display module of the extended reality device to display an extended reality content corresponding to the information to be displayed.

Optionally, in some embodiments of this application, obtaining the display state information of the extended reality device includes determining a usage scenario information of the extended reality device, determining the display state of the extended reality device according to the usage scenario information and at least one preset trigger reference condition, and generating the display state information according to the display state of the extended reality device.

Optionally, in some embodiments of this application, determining the display state of the extended reality device according to the usage scenario information and the preset trigger reference condition includes identifying a scenario type corresponding to the usage scenario information and determining a target trigger reference condition from the at least one preset trigger reference condition according to the scenario type, determining a display control reference factor according to the target trigger reference condition, wherein the display control reference factor comprises at least one of time, a location, a posture, a user manipulation, a power, a user emotion, or a program operating state, and determining a real-time reference information of the display control reference factor under the usage scenario information, and setting the information display condition as the display state of the extended reality device if the real-time reference information meets the target trigger reference condition.

Optionally, in some embodiments of this application, obtaining the information to be displayed includes obtaining an attribute information of a target user holding the extended reality device and an environmental scenario information of a current location of the target user, and determining the information to be displayed according to the environmental scenario information and the attribute information.

Optionally, in some embodiments of this application, controlling the optical display module of the extended reality device to display the extended reality content corresponding to the information to be displayed includes determining a display priority according to the attribute information and the information type corresponding to the information to be displayed, determining a display depth information of the information to be displayed according to the display priority, and presenting the extended reality content corresponding to the information to be displayed through the optical display module according to the display depth information.

Optionally, in some embodiments of this application, presenting the extended reality content corresponding to the information to be displayed through the optical display module according to the display depth information includes obtaining a posture information of the extended reality device, determining a display position information of the information to be displayed according to the posture information and the display priority, and presenting the extended reality content corresponding to the information to be displayed through the optical display module according to the display depth information and the display position information.

Optionally, in some embodiments of this application, presenting the extended reality content corresponding to the information to be displayed through the optical display module according to the display depth information and the display position information includes determining a display style information of the information to be displayed according to the display priority, and presenting the extended reality content corresponding to the information to be displayed through the optical display module according to the display depth information, the display position information, and the display style information.

Optionally, in some embodiments of this application, presenting the extended reality content corresponding to the information to be displayed through the optical display module according to the display depth information and the display position information includes capturing a preview image visible through the optical display module using a camera of the extended reality device, determining a background content information corresponding to the information to be displayed from the preview image according to the display position information, adjusting an initial display style information of the information to be displayed according to a content tone of the background content information to obtain a target display style information, and presenting the extended reality content corresponding to the information to be displayed through the optical display module according to the display depth information, the display position information, and the target display style information.

Optionally, in some embodiments of this application, determining the information to be displayed according to the environmental scenario information and the attribute information includes determining a behavioral intent of the target user according to the environmental scenario information and the attribute information, setting a content information corresponding to the behavioral intent stored in a preset memory as the information to be displayed, and/or outputting the information to be displayed corresponding to the behavioral intent through an intent-content relationship model.

Optionally, in some embodiments of this application, prior to obtaining the display state information of the extended reality device, the method further includes obtaining an original display information, if the display state of the extended reality device represents that information display condition is satisfied, obtaining the information to be displayed includes setting the original display information as the information to be displayed if the display state of the extended reality device represents that the information display condition is satisfied, or generating a display content control information and filtering the information to be displayed from the original display information according to the display content control information if the display state of the extended reality device represents that information display condition is satisfied.

In a second aspect, accordingly, embodiments of this application also provide a device for controlling an extended reality content display, applied to an extended reality device, the device includes a first obtainer configured to obtain a display state information of the extended reality device, wherein the display state information indicates a display state of the extended reality device, a second obtainer configured to obtain an information to be displayed if the display state of the extended reality device represents that an information display condition is satisfied, and a displayer configured to control an optical display module of the extended reality device to display an extended reality content corresponding to the information to be displayed.

Optionally, in some embodiments of this application, the first obtainer includes an information determiner configured to determine a usage scenario information of the extended reality device, a state determiner configured to determine the display state of the extended reality device according to the usage scenario information and at least one preset trigger reference condition, and a state information generator configured to generate the display state information according to the display state of the extended reality device.

Optionally, in some embodiments of this application, the state determiner includes a scenario sub-determiner configured to identify a scenario type corresponding to the usage scenario information and determine a target trigger reference condition from at least one preset trigger reference condition according to the scenario type, a factor sub-determiner configured to determine a display control reference factor according to the target trigger reference condition, wherein the display control reference factor comprises at least one of time, a location, a posture, a user manipulation, a power, a user emotion, or a program operating state, and a state sub-setter configured to determine a real-time reference information of the display control reference factor under the usage scenario information and set the information display condition to the display state of the extended reality device if the real-time reference information satisfies the target trigger reference condition.

Optionally, in some embodiments of this application, the second obtainer includes an environment information obtainer configured to obtain an attribute information of a target user holding the extended reality device and an environmental scenario information where the target user is currently located, and a display information determiner configured to determine the information to be displayed according to the environmental scenario information and the attribute information.

Optionally, in some embodiments of this application, the displayer includes a priority determiner configured to determine a display priority according to the attribute information and an information type of the information to be displayed, a depth information determiner configured to determine a display depth information of the information to be displayed according to the display priority, and a content displayer configured to present an extended reality content corresponding to the information to be displayed through the optical display module according to the display depth information.

Optionally, in some embodiments of this application, the content displayer includes a posture information sub-obtainer configured to obtain a posture information of the extended reality device, a position information sub-determiner configured to determine a display position information of the information to be displayed according to the posture information and the display priority, and a content sub-displayer configured to present the extended reality content corresponding to the information to be displayed through the optical display module according to the display depth information and the display position information.

Optionally, in some embodiments of this application, the content sub-displayer is further configured to determine a display style information of the information to be displayed according to the display priority and present the extended reality content corresponding to the information to be displayed through the optical display module according to the display depth information, the display position information, and the display style information.

Optionally, in some embodiments of this application, the content sub-displayer is further configured to capture a preview image through a camera of the extended reality device that previews a content through the optical display module, determine a background content information corresponding to the information to be displayed from the preview image according to the display position information, adjust an initial display style information of the information to be displayed according to a content tone of the background content information to obtain a target display style information, and present the extended reality content corresponding to the information to be displayed through the optical display module according to the display depth information, the display position information, and the target display style information.

Optionally, in some embodiments of this application, the display information determiner includes an intent sub-determiner configured to determine a behavioral intent of the target user according to the environmental scenario information and the attribute information, a first sub-setter configured to set a content information corresponding to the behavioral intent in a preset memory as the information to be displayed, and/or a second sub-setter configured to output the information to be displayed corresponding to the behavioral intent through an intent-content relationship model.

Optionally, in some embodiments of this application, the device further includes a display information obtainer, the display information obtainer includes a display information obtainer configured to obtain an original display information, and the second obtainer includes a first sub-obtainer configured to set the original display information as the information to be displayed if the display state of the extended reality device represents that an information display condition is satisfied, or a second sub-obtainer configured to generate a display content control information and filter the information to be displayed from the original display information according to the display content control information if the display state of the extended reality device represents that the information display condition is satisfied.

In a third aspect, embodiments of this application further provide an electronic equipment, which includes a memory, a processor, and a computer program stored in the memory and executable on the processor. When executed by the processor, the computer program implements steps of the above-mentioned method for controlling an extended reality content display.

In a fourth aspect, embodiments of this application further provide a computer-readable storage medium. The computer-readable storage medium stores a computer program that, when executed by a processor, implements steps of the above-mentioned method for controlling an extended reality content display.

In a fifth aspect, embodiments of this application further provide a computer program product or computer program. The computer program product or computer program includes computer instructions stored on a computer-readable storage medium. A processor of the computing device reads the computer instructions from the computer-readable storage medium, and upon execution of the instructions by the processor, the computing device performs the method provided in the various optional implementations of the embodiments of this application.

In summary, the embodiments of this application achieve control over the timing of content display on extended reality devices by obtaining the display state information of the extended reality device and controlling the acquisition and display of information to be displayed according to the display state indicated by the display state information. This ensures that the display state serves as the condition for content display on the extended reality device, thereby avoiding unrestrained, unconstrained, and random content display. It enhances performance of content display on the extended reality device and improves a user experience. The subject matter claimed herein is not limited to embodiments that solve any disadvantages or that operate only in environments such as those described above. Rather, this background is only provided to illustrate one exemplary technology area where some embodiments described herein may be practiced.

### BRIEF DESCRIPTION OF THE DRAWINGS

To further clarify the technical solutions in this application, a brief introduction to the drawings used in the description of the embodiments is provided below. It is evident that the drawings described below are merely some embodiments of the present invention. For those skilled in the art, other drawings may also be derived from these drawings without involving inventive efforts.

FIG. 1 is a schematic diagram of a scenario for a method for controlling an extended reality content display according to an embodiment of this application.

FIG. 2 is a flowchart illustrating a method for controlling an extended reality content display according to an embodiment of this application.

FIG. 3 is a schematic diagram of a depth information on a screen of an extended reality device according to an embodiment of this application.

FIG. 4 is a schematic diagram of a display area on a screen of an extended reality device according to an embodiment of this application.

FIG. 5 is a schematic diagram of a control performance of an extended reality content display before a trip according to an embodiment of this application.

FIG. 6 is a schematic diagram of a control performance of an extended reality content display during a trip according to an embodiment of this application.

FIG. 7 is a schematic diagram of a control performance of an extended reality content display after a trip according to an embodiment of this application.

FIG. 8 is a flowchart of an extended reality device executing a method for controlling an extended reality content display according to an embodiment of this application.

FIG. 9 is a schematic diagram of a structure of a device for controlling an extended reality content display according to an embodiment of this application.

FIG. 10 is a schematic diagram of a structure of an electronic equipment according to an embodiment of this application.

### DETAILED DESCRIPTION OF THE PREFERRED EMBODIMENTS

The technical solutions in this application will be described clearly and comprehensively below in conjunction with the accompanying drawings. It is evident that the described embodiments are merely part of the invention and not all embodiments. Based on the embodiments of the present invention, all other embodiments that can be derived by those skilled in the art without making inventive efforts are within the scope of protection of the invention.

The embodiments of this application provide a method for controlling an extended reality content display, a device, an electronic equipment, and a computer-readable storage medium. Specifically, this application provides a device for controlling an extended reality content display applicable to an electronic equipment. The electronic equipment may include an extended reality (XR) device, which encompasses a virtual reality (VR) device, an augmented reality (AR) device, and a mixed reality (MR) device. In the embodiments of this application, the extended reality device at least includes products in the form of glasses or head-mounted display devices. Correspondingly, the extended reality device may at least be an optical see-through or video see-through product.

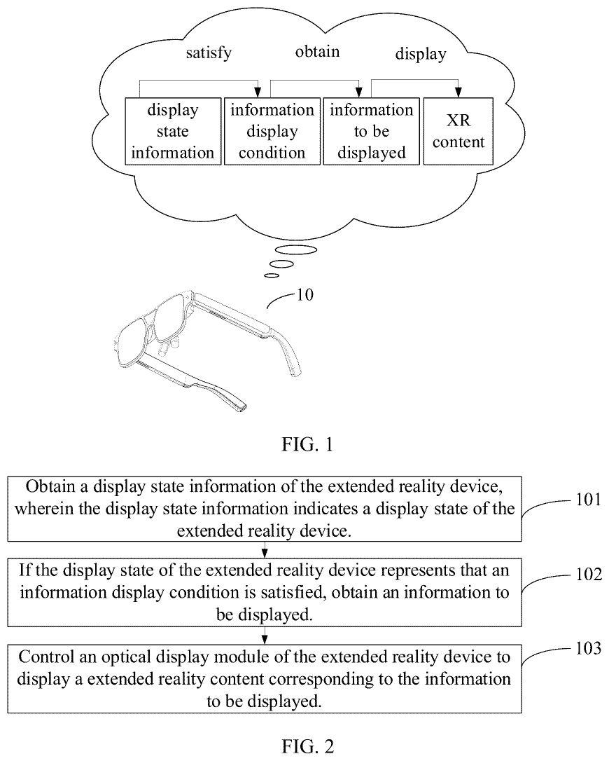

Refer to FIG. 1, which is a schematic diagram of a scenario where an extended reality device (e.g., optical see-through wearable smart AR glasses) executes a method for controlling an extended reality content display according to an embodiment of this application. The specific execution process of this method by the extended reality device is as follows.

An extended reality device 10 obtains a display state information of the extended reality device 10, wherein the display state information indicates a display state of the extended reality device 10. If the display state of the extended reality device 10 represents that an information display condition is satisfied, the extended reality device 10 obtains an information to be displayed and controls an optical display module of the extended reality device 10 to display an extended reality content corresponding to the information to be displayed.

In some embodiments, the display state information is obtained, and the acquisition and display of the information to be displayed are controlled according to the display state indicated by the display state information. This achieves the use of the display state as a condition for displaying information on the extended reality device 10, ensuring control over timing of content display, avoiding unrestrained and random content display, and enhancing a performance and a user experience of content display on the extended reality device 10.

The detailed explanation follows below. It should be noted that the sequence of the descriptions of the embodiments does not imply any priority among the embodiments.

Refer to FIG. 2, which is a flowchart of a method for controlling an extended reality content display according to an embodiment of this application. Although the logical sequence is shown in the flowchart, in some cases, the steps described or shown can be executed in an order different from that indicated in the drawings.

A method for controlling an extended reality content display is applied to an extended reality device, and the specific flow of the method is as follows.

Step 101: Obtain a display state information of the extended reality device, wherein the display state information indicates a display state of the extended reality device.

It should be noted that the display state indicates whether the extended reality device has, meets, or can satisfy at least one information display condition. For example, in this application, the display state includes at least one of the following: satisfying the at least one information display condition or not satisfying the at least one information display condition. Satisfying the at least one information display condition indicates that the extended reality device meets the at least one information display condition. From the user's perspective, this means the current moment is suitable for displaying information. From the device's perspective, the software and hardware modules are in a state capable of handling information display at the current moment.

The display state information is a form of presenting the display state, such as text, symbols, graphics, charts, numbers, or combinations thereof. According to the display state information, the display state of the extended reality device can be indicated or reflected.

Obtaining the display state information helps control the display of information on the extended reality device according to the display state indicated by the display state information.

Step 102: If the display state of the extended reality device represents that an information display condition is satisfied, obtain an information to be displayed.

It should be noted that the information display condition refers to a condition that needs to be met for information display. For example, the information display condition can include time, a location, a weather, a user action, a voice command, or a device battery level. In this application, for instance, a scheduled task is set, and information to be displayed is automatically obtained and displayed when the set time is reached. Alternatively, when a user carrying the extended reality device reaches a specific location, the information to be displayed is triggered and obtained.

In such cases, the set time for the scheduled task and the location that triggers the acquisition of information to be displayed constitute the information display condition.

It is understood that the information to be displayed refers to the information intended for display through the extended reality device. This information may include various types, such as weather updates, email notifications, social media updates, entertainment information, or news.

It can be appreciated that the information to be displayed is only retrieved when the display state represents that an information display condition is satisfied. This makes the display state a control condition for retrieving the information to be displayed. Specifically, the information is only retrieved when the condition is met; otherwise, it is not retrieved. This effectively avoids the acquisition of irrelevant information and prevents resource wastage.

In the embodiments of this application, the information display condition can be preset and fixed. For example, the condition may be a specific fixed time or location, meaning that reaching this fixed time or location triggers the retrieval of the information to be displayed.

Correspondingly, the information display condition can also be dynamically variable. For instance, the condition may change with a factor such as date, a usage duration, or a device battery level. For example, with increased usage duration, the condition may shift from location A to location B. Similarly, with seasonal changes, such as transitioning from summer to autumn or autumn to winter, the condition may advance the retrieval time for the information to be displayed. For instance, the retrieval time originally set for 9:00 PM may be adjusted to 7:00 PM to accommodate earlier sleep schedules during winter.

As another example, prolonged use of the extended reality device may extend the information display condition beyond specific locations. It could include other locations, the user's current real-time location, or multiple locations. For instance, after prolonged device usage, not only the bedroom but also the living room or bathroom may trigger the retrieval of eye protection information.

Fixed configurations for information display conditions facilitate user-defined customization, allowing flexible configuration according to individual needs. Dynamic configurations, on the other hand, support adaptive adjustments to information retrieval timing, addressing diverse requirements under varying environments, considerations, or circumstances.

Step 103: Control an optical display module of the extended reality device to display a extended reality content corresponding to the information to be displayed.

It should be noted that the optical display module is a component of the extended reality device responsible for displaying extended reality content. This optical display module may comprise a combination of optical elements, such as a microdisplay, a sensor, a combiner, a lens, and a projector.

It can be understood that by retrieving the information to be displayed after satisfying the information display conditions and controlling the extended reality device to display the corresponding content, the method achieves effective control of the device's display. This prevents the unrestrained and random display of content, allowing for precise control over the timing and content of the display. It reduces the presentation of irrelevant content.

The information display conditions may also be user-defined, enabling the retrieval of information and the display of corresponding extended reality content only under specific conditions. This ensures control over the device's displayed content, enhancing the performance of content display and improving the user experience.

Optionally, in this application, a trigger reference condition can be set. When the trigger reference condition is met, a display state satisfying the information display condition is generated. Conversely, when the trigger reference condition is not met, a display state not satisfying the information display condition is generated. For example, if the time is between 7:00 PM and 9:00 PM, the display state can be set to satisfy the information display condition. Conversely, if the extended reality device is used in scenarios such as meetings, gaming, or immersive movie viewing, the display state can be set to not satisfy the information display condition.

In one embodiment of this application, the information to be displayed is not the information currently being used by the extended reality device but rather additional information other than the current content. For example, during the use of a first application on the extended reality device, the information to be displayed may be data collected by a second application other than the first application. For instance, when a user is using a map application on the extended reality device, upon reaching a specific location, a food recommendation application can be launched to retrieve information about nearby restaurants.

Correspondingly, the trigger reference condition can also be dynamically adjusted according to changes in time, device familiarity, usage frequency, holidays, weather, or temperature. For instance, when the usage duration of the extended reality device exceeds a preset threshold, the trigger reference condition may be adjusted from G to H, thereby changing the device's display state from not satisfying the information display conditions to satisfying them. This enables the device to trigger the retrieval of information to be displayed. For example, after prolonged continuous use, the trigger reference condition may be reduced from two hours to one hour. When one hour is reached, the extended reality device is deemed to satisfy the information display condition, triggering the retrieval of eye protection reminders. Similarly, in gaming or office scenarios, prolonged focus may lead to overlooked notifications. Therefore, the message reminder interval can be shortened after extended use, such as triggering message retrieval after one hour.

Additionally, the trigger reference condition can be a combination of multiple factors, such as time, weather, and user mood. For instance, if the user is in a calm mood, with favorable weather and comfortable temperature, the display state may be set to satisfy the information display conditions, indicating it is suitable for processing information. Conversely, if the user is in a calm mood but the weather is poor or the temperature is too high or low, the display state may be set to not satisfy the information display conditions, as the conditions for processing information are deemed unfavorable.

Optionally, in this embodiment, whether the information display condition is satisfied can also be analyzed and determined according to the usage scenario of the extended reality device. Specifically, in some embodiments of this application, the step of “obtaining the display state information of the extended reality device” includes determining a usage scenario information of the extended reality device, determining the display state of the extended reality device according to the usage scenario information and at least one preset trigger reference condition, and generating the display state information according to the display state of the extended reality device.

It is understood that usage scenario information refers to a contextual information of the extended reality device's usage, such as scenarios including resting, traveling, working, shopping, or exercising. It may also refer to specific locations, such as waiting halls, shopping malls, homes, or parks.

The preset trigger reference condition refers to a predefined condition that is met to retrieve the information to be displayed. It serves as the trigger for the extended reality device to obtain the information. The condition type of the preset trigger reference condition can include time, location, device posture, or device battery level. In this embodiment, the display state of the extended reality device can be determined by analyzing and combining multiple types of preset trigger reference conditions.

By integrating the usage scenario information of the extended reality device, an accuracy of display state generation can be improved. For example, the display state is set to satisfy the information display condition only when the extended reality device's current usage scenario meets specific criteria. Specifically, a resting scenario may correspond to not satisfying the information display condition, while an exercise scenario may correspond to satisfying the information display condition.

Optionally, in this embodiment, the trigger reference condition can be specifically set for different usage scenarios of the extended reality device, establishing a one-to-one correspondence between preset trigger reference conditions and usage scenarios. The extended reality device determines whether the trigger reference condition corresponding to the scenario is satisfied and, based on this, generates or sets the display state. Specifically, in some embodiments of this application, the step “determining the display state of the extended reality device according to the usage scenario information and preset trigger reference condition” includes identifying a scenario type corresponding to the usage scenario information and determining a target trigger reference condition from the at least one preset trigger reference condition according to the scenario type, determining a display control reference factor according to the target trigger reference condition, wherein the display control reference factor comprises at least one of time, a location, a posture, a user manipulation, a power, a user emotion, or a program operating state, and determining a real-time reference information of the display control reference factor under the usage scenario information, and setting the information display condition as the display state of the extended reality device if the real-time reference information meets the target trigger reference condition.

For example, in an office scenario type, a specific time period can be set as the trigger reference condition, while in a gaming scenario, the battery level range can be set as the trigger reference condition. Correspondingly, in the office scenario, when the specific time period is reached, the display state is set to not satisfy the information display conditions. In the gaming scenario, when the battery level of the extended reality device reaches the preset battery range, the display state is set to not satisfy the information display condition.

The scenario type refers to the type of usage scenario for the extended reality device, such as home, park, waiting hall, or activities like traveling, working, and entertainment. Each scenario type can correspond to one or more target trigger reference conditions. For example, the home scenario may include time and battery as target trigger reference conditions, while the work scenario may correspond to time, location, and battery as the trigger reference condition.

The display control reference factor is determined according to a reference object of the target trigger reference condition. For instance, if the target trigger reference condition focuses on time, the display control reference factor will also be time; if the target trigger reference condition focuses on location, the display control reference factor will likewise be location. Typically, there is a one-to-one relationship between display control reference factors and target trigger reference conditions. However, when the target trigger reference condition focuses on multiple reference objects, there will be multiple corresponding display control reference factors. For example, if the target trigger reference condition focuses on time and location, the display control reference factors will include both time and location.

After determining the target trigger reference condition for a scenario type according to the scenario type, the display control reference factor for that scenario type can be determined according to the target trigger reference conditions. Then, the corresponding real-time reference information can be extracted from the usage scenario information according to the display control reference factors. For instance, if the scenario type is “home” and the target trigger reference condition is a time period, the corresponding display control reference factor is time. The real-time time of the usage scenario (i.e., the real-time reference information) can then be obtained. By comparing the real-time time of the usage scenario with the time period of the target trigger reference condition, it can be determined whether the information display conditions are satisfied. If the time falls within the period, the information display conditions are satisfied; otherwise, they are not. The extended reality device can request and receive the current accurate time from a server using the Network Time Protocol (NTP).

It should be noted that “posture” refers to the physical posture of the user or wearer of the extended reality device, describing the orientation or movement of the user's head or other body parts in space, such as tilting the head up, down, or side to side. In this embodiment, the posture of the user's head or other body parts can be obtained through built-in sensors in the extended reality device, such as a gyroscope, accelerometer, or magnetometer. These sensors capture the posture of the extended reality device, which is then calculated using 6DoF algorithms to determine the user's head posture. Additionally, gestures can be captured using the device's camera, and gesture recognition algorithms can then calculate the user's hand gestures.

In this embodiment, the changes in the posture of the user or wearer of the extended reality device are used as control conditions for displaying information on the device. This allows the extended reality device to control the display according to specific user or wearer actions, enhancing the diversity of information display control methods and improving the user experience.

Battery level refers to the battery status of the extended reality device. User control refers to the user's active operation of the device, including voice commands, button controls, gesture-based guidance, eye-gaze control, or other eye-based operations. User emotions refer to the user's emotional state, such as joy, tension, anxiety, or anger. Program running state refers to the operating status of applications on the extended reality device, such as running or not running. It can also include whether the program has received a message or not.

In summary, this embodiment analyzes and determines the timing of information display for the extended reality device from multiple perspectives, including time, location, posture, user control, battery level, user emotions, and program running states. This effectively achieves control over the timing of information display, avoids the unrestrained and random display of content, enhances a performance of content display on the extended reality device, and improves the user experience.

In one embodiment of this application, the information to be displayed can also be pre-collected and directly displayed when the display state characterization satisfies the information display condition.

Correspondingly, the original display information can be collected first. When the display state information indicates that the information display condition is met, the original display information can be used as the information to be displayed, or a portion of the original display information can be filtered and used as the information to be displayed. Specifically, in some embodiments of this application, the method includes the following steps before “obtaining the display state information of the extended reality device”: obtaining an original display information, if the display state of the extended reality device represents that information display condition is satisfied, obtaining the information to be displayed includes setting the original display information as the information to be displayed if the display state of the extended reality device represents that the information display condition is satisfied, or generating a display content control information and filtering the information to be displayed from the original display information according to the display content control information if the display state of the extended reality device represents that information display condition is satisfied.

It is understood that the original display information refers to information related to the extended reality content intended for display. This original display information can be collected through various sensors or received by applications on the extended reality device. Correspondingly, this information can also be obtained by the device's applications actively acquiring data via instructions through the internet or local networks.

In this embodiment, the original display information can be collected either continuously or periodically. Once the information display conditions are met, the original display information can be directly set as the information to be displayed for presentation on the extended reality device, or a portion of the original display information can be filtered according to factors such as user emotions, the current usage scenario of the device, or the priority of the information.

In this embodiment, the display state information can also be adjusted according to the original display information. For example, after acquiring the original display information, the priority of the information can be identified or analyzed, and the display state information can be determined according to this priority. If the priority of the original display information is high, the display state information is set to satisfy the information display conditions; if the priority is low, the display state information is set to not satisfy the information display conditions.

By controlling the display state information according to the priority of the original display information, the retrieval of information to be displayed can be effectively managed. When the priority of the original display information is high, it is more likely to trigger the retrieval and subsequent display of the information to be displayed. Conversely, when the priority is low, it is less likely to trigger these actions.

In this embodiment, display content control information refers to the criteria or basis for filtering the information to be displayed from the original display information. For example, the display content control information can include priority, chronological order, content size, or keywords. High-priority, earlier, or larger pieces of information can be extracted from the original display information as the information to be displayed. Alternatively, keywords or key phrases can be extracted from the original display information and used as the information to be displayed to enhance the presentation of critical information or streamline the displayed content.

In this embodiment, the acquisition of original display information and the acquisition of display state information do not have a strict chronological order. For instance, original display information can be collected first, followed by acquiring or determining the display state of the extended reality device. Alternatively, the original display information can be collected simultaneously or after acquiring or determining the device's display state.

Optionally, in this embodiment, the information to be displayed can be collected according to the user's attributes and the environmental scenario information of the user's current location. Specifically, in some embodiments, the step “obtaining the information to be displayed” includes obtaining an attribute information of a target user holding the extended reality device and an environmental scenario information of a current location of the target user and determining the information to be displayed according to the environmental scenario information and the attribute information.

It should be noted that attribute information refers to the user's personalized information, including physiological data, habits, work schedules, or life arrangements. Environmental scenario information refers to information about the user's current environment, which can be derived according to the user's location or setting. For example, if the user is in a waiting hall, the environmental scenario is a waiting scenario. If the user has just deplaned, the scenario is an arrival scenario. If the user is sitting at home, the scenario is a home leisure scenario.

In this embodiment, the user's attribute information and scenario information can be acquired through relevant sensors. For instance, physiological data such as body temperature can be obtained using a temperature sensor, and blood pressure data can be obtained using a blood pressure sensor. The user's location and setting can be determined using a combination of GPS and camera input. For example, the geographic location of the user can be identified using a GPS module, and the camera feed can be analyzed to determine the specific environment.

On the other hand, certain attribute information, such as the user's routines, interests, and frequently visited destinations, can be automatically generated by the device through artificial intelligence and big data analysis.

In an embodiment of this application, the information to be displayed can also be generated by combining the user's attribute information and the user's environmental scenario information. This improves the alignment between the retrieved information and the user's expectations, enhancing the accuracy of the retrieved information and a performance of the extended reality device's content display. Additionally, the information to be displayed satisfies both the environmental scenario information and the user's attribute information, presenting the information in a form that is more scientific, reasonable, and comfortable for the user and appropriate for the device's state.

In an embodiment of this application, to further improve the alignment between the retrieved information and the user's expectations, additional dimensions of information can be combined to determine the information to be displayed. For example, factors such as user emotions, short-term work and life plans, weather, temperature, the type of target city, as well as device battery level and time, can be considered to assist in collecting the information to be displayed.

In this embodiment, the reference information used to determine the display state of the extended reality device and the reference information used to determine the information to be displayed can overlap or differ according to the requirements for display control and content accuracy. It is understood that an embodiment of this application does not exhaustively list all reference information required for display control or content determination. Any information that can enhance the accuracy of timing control for display or the accuracy of information retrieval is considered within the scope of an embodiment of this application.

Optional, to avoid the monotony of extended reality content display, the determined information to be displayed can be controlled for display depth according to the characteristics of the extended reality device's display depth. This enhances the diversity of extended reality content display control methods. Specifically, in some embodiments, the step “controlling the optical display module of the extended reality device to display the extended reality content corresponding to the information to be displayed” includes determining a display priority according to the attribute information and the information type corresponding to the information to be displayed, determining a display depth information of the information to be displayed according to the display priority, and presenting the extended reality content corresponding to the information to be displayed through the optical display module according to the display depth information.

Display priority refers to the priority for pushing or displaying the extended reality content, reflecting the importance of the information to be displayed. For example, it may include levels such as high, medium, and low. Higher priority indicates higher importance of the information to be displayed, and correspondingly, more important information is given higher display priority.

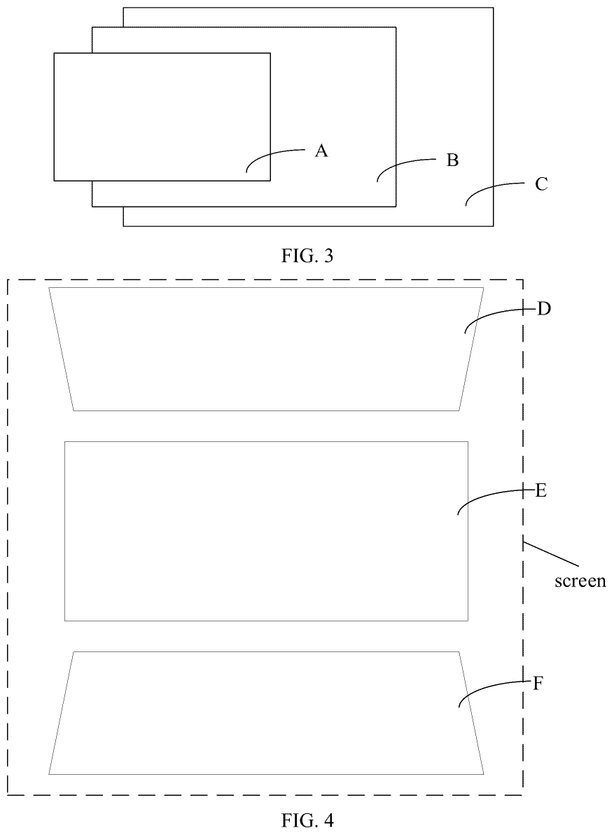

Display depth information refers to the virtual three-dimensional display depth of the content unit, which creates a sense of distance for the user. For instance, on a screen, display depth describes the sense of realism when presenting content. Refer to FIG. 3, which shows a schematic of the display depth information on the screen of an extended reality device. The screen includes three depths: foreground (A), default (B), and background (C), with increasing depth from foreground to background.

Different display depths convey varying levels of importance for the information. For instance, information presented at the foreground depth is more noticeable to the user, making it suitable for displaying highly important information. Conversely, background depth can display information of general importance. When the information to be displayed is presented at the foreground depth, it indicates that the information is highly important. Conversely, when presented at the background depth, it suggests that the information is less critical.

Determining the display depth information on the screen according to the display priority helps push or present the extended reality content at an appropriate depth. This enables content presentation according to the importance of the information, helping to draw varying degrees of user attention, avoiding user dissatisfaction from indiscriminate pushing, and enhancing the user experience.

Different display depths can attract user attention to varying degrees, aiding in categorizing and presenting information according to display priority. Users can selectively view information, further enhancing the user experience.

Optional, in an embodiment of this application, when presenting the extended reality content corresponding to the information to be displayed, the display position of the information can be determined first. The information is then presented according to this display position, further improving the accuracy of extended reality content display control. Specifically, in some embodiments, the step “presenting the extended reality content corresponding to the information to be displayed through the optical display module according to the display depth information” includes: obtaining a posture information of the extended reality device, determining a display position information of the information to be displayed according to the posture information and the display priority, and presenting the extended reality content corresponding to the information to be displayed through the optical display module according to the display depth information and the display position information.

Presenting the information to be displayed according to the display position information ensures that the information is displayed in an appropriate position, enhancing the accuracy of extended reality content display control.

Determining the display position information of the information to be displayed according to posture information ensures that the display position matches the user's behavior as reflected by the posture information. This makes the extended reality content display align with the user's expectations. For instance, users can control the display position of the information through posture. When specific user actions occur, the content can be displayed at the corresponding position. Moreover, determining the display position based on posture ensures that the position aligns with the posture information, adhering to ergonomic principles, and providing a more comfortable viewing experience for the user.

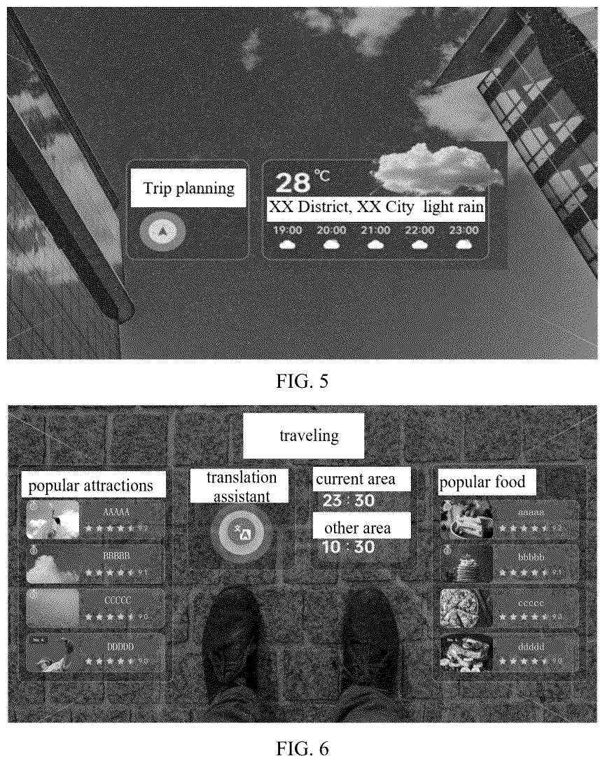

For example, refer to FIG. 4, which is a schematic diagram of a display area of a screen for an extended reality device according to an embodiment of this application. The screen includes an upper area (D), a middle area (E), and a lower area (F). Additionally, it may also include a left area, a center area, and a right area (this division is not illustrated). When the user performs a head-up action, the information to be displayed can be presented in the upper area of the screen. When the user performs a head-down action, the information can be displayed in the lower or middle area of the screen. This allows the user to quickly view the corresponding content in the respective area as their actions change. Adjusting the display position based on user behavior aligns with ergonomic principles and matches the user's visual angle or field of view during such actions, thereby improving a performance of presenting the information to be displayed.

Optional, in this embodiment, to attract the user's attention to the presented content information to varying degrees, the display style information of the information to be displayed can also be configured. Based on the display style information, the display of the information to be displayed can be controlled to further enhance the diversity of display methods and styles. Specifically, in some embodiments, the step “presenting the extended reality content corresponding to the information to be displayed through the optical display module according to the display depth information and display position information” includes determining a display style information of the information to be displayed according to the display priority and presenting the extended reality content corresponding to the information to be displayed through the optical display module according to the display depth information, the display position information, and the display style information.

By determining the display style information corresponding to the display priority, the display style information can be associated with the respective display priority. This ensures that different display priorities correspond to different display styles. Based on this, different display styles can be applied to the information to be displayed according to its importance, drawing varying degrees of user attention and enhancing the diversity of display methods or styles in extended reality content display control, thereby improving the user experience.

It is understood that display styles include fonts, lines, colors, positions, and other style elements. Based on different display priorities, various effects such as bold lines, deepened colors, or highlighted positions can be used to display the information, creating different levels of appeal and drawing varying degrees of user attention.

Correspondingly, in this embodiment, the optical display module can also display other types of content, such as video content, gaming scene content, or real-world content. For instance, the information to be displayed can be overlaid on video content, allowing users to view additional information while watching videos.

In this embodiment, the screen can also be a transparent screen, allowing users to view real-world content through it while projecting extended reality content. For example, the screen may belong to augmented reality (AR) devices, such as AR glasses. The screen's transparency enables users to see real-world objects through the screen while also projecting extended reality content onto it using technologies like waveguide optics. This creates an overlay of extended reality content on the real-world scene.

For such information overlaid on real-world content, the display position can be determined based on its corresponding display position information to check whether it overlaps with the real-world content. Display styles can then be adjusted to either highlight the information to be displayed or minimize its impact on the real-world content. Specifically, in some embodiments, the step “presenting the extended reality content corresponding to the information to be displayed through the optical display module according to the display depth information and display position information” includes capturing a preview image visible through the optical display module using a camera of the extended reality device, determining a background content information corresponding to the information to be displayed from the preview image according to the display position information, adjusting an initial display style information of the information to be displayed according to a content tone of the background content information to obtain a target display style information, and presenting the extended reality content corresponding to the information to be displayed through the optical display module according to the display depth information, the display position information, and the target display style information.

In an embodiment of this application, real-world content refers to the content observed by the user through the optical display module (e.g., screen) of the extended reality device. Correspondingly, a camera with the same field of view can be configured to capture the real-world content viewed by the user through the screen. In other words, the preview image captured by the camera matches the real-world content. Based on the display position information of the information to be displayed, it can be determined whether there is overlapping background content in the preview image. Subsequently, the display style of the information to be displayed can be adjusted.

Optional, in this embodiment, the initial display style information refers to the display style of the information to be displayed before adjustments are made based on the content tone of the background content. The initial display style may be a default style, for example, obtained through initialization configuration, such as white font. Alternatively, the initial display style can be adjusted from the default style based on factors such as the display priority of the information to be displayed. For instance, the default white font can be changed to red font. Correspondingly, the target display style information obtained after adjusting the initial display style may include blue font.

To reduce the impact on real-world content, the display chroma or color depth of the information to be displayed can be reduced during display. For example, the blue font style can be changed to white or light-colored font.

In an embodiment of this application, the display position, display depth, and display style of extended reality content can collectively be referred to as the display form. The display form can also be set dynamically. For example, the display form of certain information to be displayed can be adjusted based on factors such as the battery level, device temperature, ambient temperature, user emotions, or continuous display duration of the extended reality device. For instance, when the battery level drops below a threshold, the device temperature reaches a temperature threshold, or the continuous display duration exceeds a time threshold, the font size of the displayed content can be reduced, the color brightness can be lowered, or the extended reality content can be moved to another display position (e.g., a position less noticeable to the user).

Taking a travel application scenario as an example, refer to FIG. 5 to FIG. 7, which respectively illustrate performances of extended reality content display control before, during, and after a trip.

Referring to FIG. 5, before the trip, daily information analysis identifies that the user is about to embark on a journey. When the user looks up, weather information is displayed along with relevant services such as itinerary planning, currency exchange, etc. Additionally, the smart assistant in the extended reality device can provide customized reminders based on the user's itinerary, such as the best departure time, flight time, weather conditions, and traffic status.

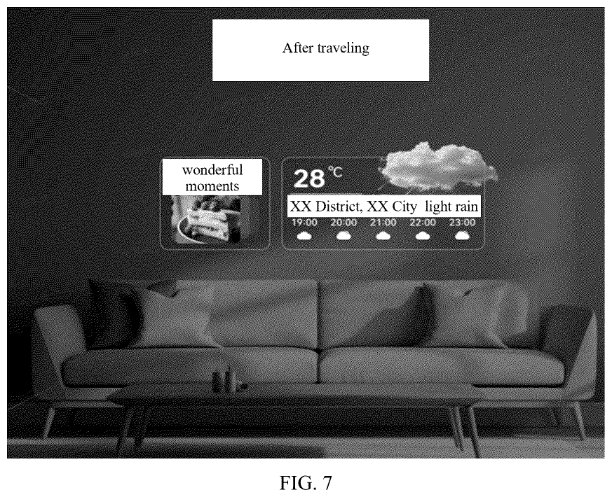

Referring to FIG. 6, during the trip, when the user looks down at the ground, relevant information such as meeting schedules, local restaurant recommendations, or local weather conditions can be automatically displayed based on the user's location, behavior, and preferences.

Referring to FIG. 7, after the trip, the extended reality device can help the user organize travel highlights, such as photos, videos, and memos. For example, when the user is sitting on a sofa at home and looks up, in addition to seeing weather information, highlights from the trip, such as memorable photos and moments, can be displayed. The user can then choose to share these moments with one click on social media platforms.

Optional, in this embodiment, to enhance the accuracy of extended reality content display control, i.e., the accuracy of recommended information to be displayed, the user's intent can be inferred based on environmental scenario information and attribute information. The recommended information to be displayed can then be determined based on this intent. Specifically, in some embodiments, the step “determining the information to be displayed according to the environmental scenario information and the attribute information” includes determining a behavioral intent of the target user according to the environmental scenario information and the attribute information, setting a content information corresponding to the behavioral intent stored in a preset memory as the information to be displayed, and/or outputting the information to be displayed corresponding to the behavioral intent through an intent-content relationship model.

Behavioral intent refers to a specific goal that a user aims to achieve, such as the intent to view nearby store information, hotel information, or share content.

By combining environmental scenario information with the user's attribute information, the accuracy of behavioral intent recognition can be improved. For example, the user's behavioral intent can be inferred from their actions in specific scenarios, such as looking up while waiting for a bus (where the scenario information is “waiting for a bus” and the behavioral action is “looking up”), looking down after deplaning, looking up while sitting idly at home, or turning their head while working in the office.

In an embodiment of this application, a preset memory stores various content information corresponding to behavioral intents suitable for the user. By analyzing the user's behavioral intent, the corresponding information to be displayed can be matched from the preset memory. Furthermore, a knowledge graph can be constructed to establish a mapping relationship between the behavioral intent and the information to be displayed through the correspondence between behavioral intents and entities in the graph. The relationship between behavioral intents and the information to be displayed can also be derived through big data or machine learning methods.

Correspondingly, in this embodiment, the intent-content relationship model defines the relationship between intent and content. Once the user's behavioral intent is identified, the model outputs the information to be displayed that aligns with the intent. This relationship model is trained using large datasets to capture associations between variables for tasks such as prediction, classification, or regression. Using the intent-content relationship model, the information to be displayed corresponding to the user's behavioral intent can be predicted. For example, the model can predict the type of information needed for the current intent, and based on the type, retrieve the information to be displayed from local content or obtain it from the cloud or server via a network, such as retrieving weather data for a travel destination.

Optional, in this embodiment, the posture information of the extended reality device can be obtained through its sensors and cameras. For instance, the current posture of the device can be analyzed based on the camera's viewing angle and motion data from sensors. Specifically, in some embodiments, the step “obtaining the posture information of the extended reality device” includes capturing a preview image using the camera of the extended reality device, analyzing a current shooting angle of the camera according to the preview image, determining a tilt angle of the extended reality device using an angle detection sensor; combining the current shooting angle and the tilt angle to determine the posture information of the extended reality device.

The angle detection sensor may include a built-in device such as a gyroscope, an accelerometer, and a magnetometer.

By analyzing the device's posture information through a combination of the shooting angle and the tilt angle, the accuracy of posture information can be enhanced. The shooting angle and the tilt angle can be weighted appropriately to improve the analysis and determination of the device's posture information.

In summary, an embodiment of this application enables effective control of the timing of content display by obtaining the display state information of the extended reality device and using the indicated display state to manage the retrieval and presentation of the information to be displayed. By using the display state as the condition for content display, it avoids indiscriminate or uncontrolled random displays, enhances a performance of the displayed information, and improves a user experience.

By obtaining the posture information of the extended reality device and proceeding to obtain user attribute information and scenario information only when the posture information satisfies preset trigger conditions, the recommended information to be displayed can be identified and suggested. This approach allows precise control over the timing of extended reality content display, improving its accuracy, ensuring recommendations occur when needed, and ultimately enhancing a performance of extended reality content display control and a user experience.

By determining the recommended information to be displayed based on the user's attribute information and current scenario information, the accuracy of the information to be displayed is improved. When recommendations are made based on this information, the accuracy and performance of extended reality content display control are enhanced.

Leveraging the characteristics of the extended reality device's screen, the information to be displayed can be output at different display depths. This not only enriches the diversity of display styles but also enables recommendations based on the importance of different information. This approach avoids user frustration caused by indiscriminate control of extended reality content display and helps improve a performance and accuracy of content recommendations.

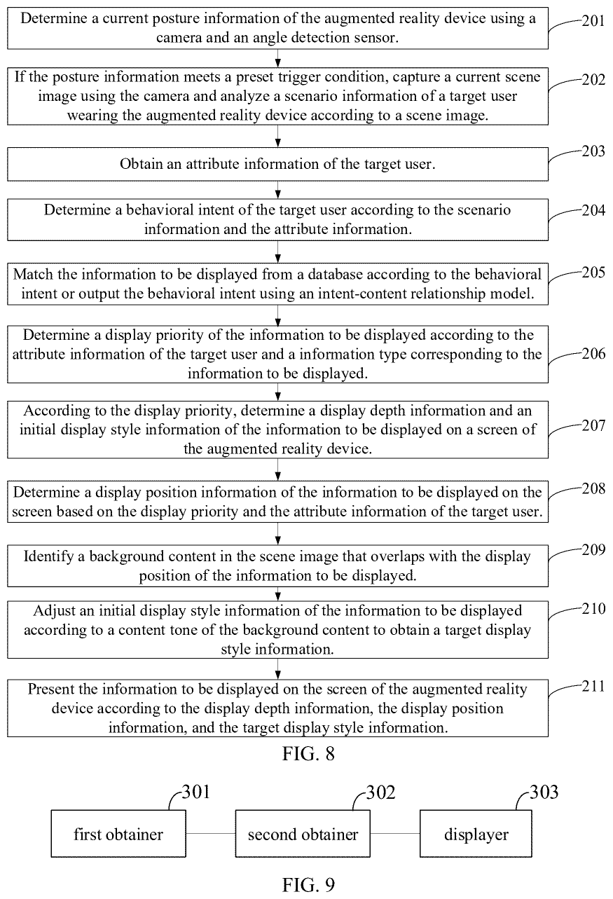

To facilitate the understanding of this embodiment, an optical projection-based augmented reality (AR) device is used as an example of an extended reality device. Specifically, refer to FIG. 8, which illustrates the workflow of the augmented reality device executing the method for controlling an augmented reality content display. The specific steps are as follows.

Step 201: Determine a current posture information of the augmented reality device using a camera and an angle detection sensor.

Step 202: If the posture information meets a preset trigger condition, capture a current scene image using the camera and analyze a scenario information of a target user wearing the augmented reality device according to a scene image.

GPS can also be used to obtain a geographic location information, which, when combined with the scene image, helps accurately determine the target user's current scenario information.

Step 203: Obtain an attribute information of the target user.

This attribute information includes physiological data and behavioral action data obtained through body sensors, as well as user habits, recent work plans, and life arrangements retrieved from memory.

Step 204: Determine a behavioral intent of the target user according to the scenario information and the attribute information.

Step 205: Match the information to be displayed from a database according to the behavioral intent or output the behavioral intent using an intent-content relationship model.

Step 206: Determine a display priority of the information to be displayed according to the attribute information of the target user and a information type corresponding to the information to be displayed.

Step 207: According to the display priority, determine a display depth information and an initial display style information of the information to be displayed on a screen of the augmented reality device.

Step 208: Determine a display position information of the information to be displayed on the screen based on the display priority and the attribute information of the target user.

Step 209: Identify a background content in the scene image that overlaps with the display position of the information to be displayed.

Step 210: Adjust an initial display style information of the information to be displayed according to a content tone of the background content to obtain a target display style information.

Step 211: Present the information to be displayed on the screen of the augmented reality device according to the display depth information, the display position information, and the target display style information.

The screen of the augmented reality device has a certain level of transparency, allowing users to view real-world content through it. Additionally, technologies such as diffractive waveguides can be used to project augmented reality content onto the screen.

The posture information of the augmented reality device reflects the behavioral actions of the user wearing it. Therefore, using posture information as a basis for determining the timing of augmented reality content display effectively uses the user's behavioral actions as timing conditions. This approach enables augmented reality content display control after specific actions are performed, avoiding the inaccuracies and user frustration associated with indiscriminate or purely location-based display control. This enhances the accuracy of recommendations, a performance of content, and an overall user experience.

By determining the recommended information to be displayed through scenario information combined with user attributes, an accuracy of the information to be displayed is further improved, enhancing the accuracy of augmented reality content display control and a user experience.

Additionally, the augmented reality device in an embodiment an embodiment of this application offers the following advantages when performing augmented reality content display control.

Personalized Information Presentation: The system presents information based on the user's specific scenario and intent, enabling the user to access information relevant to their current needs, thereby enhancing personalization and practicality.

Smarter Information Retrieval: By considering the user's behavioral traits, physiological data, and intent, the system intelligently presents information, reducing the need for manual intervention and providing a more automated and convenient information retrieval process.

More Intuitive User Experience: Presenting information in appropriate scenarios, at the right time, and based on user intent creates a more intuitive interaction and natural user experience, reducing cognitive load.

Improved Work Efficiency: For professional and industrial applications, the system can enhance work efficiency and reduce error rates by intelligently providing relevant information.

Enhanced Quality of Life: In daily life, the system provides users with more convenient ways to access information, thereby improving quality of life and reducing stress.

To better implement a method for controlling the extended reality content display described in this application, a device for controlling an extended reality content display according to the above method is also provided. The terminology used here has the same meaning as in the method for controlling an extended reality content display described above, and specific implementation details can be referenced in the method embodiments.

Refer to FIG. 9, which is a schematic diagram of a structure of a device for controlling an extended reality content display according to an embodiment of this application. The device is applied to the extended reality device and can be specifically designed as follows: a first obtainer 301 configured to obtain a display state information of the extended reality device, wherein the display state information indicates a display state of the extended reality device, a second obtainer 302 configured to obtain an information to be displayed if the display state of the extended reality device represents that an information display condition is satisfied, and a displayer 303 configured to control an optical display module of the extended reality device to display an extended reality content corresponding to the information to be displayed.

Optionally, in some embodiments of this application, the first obtainer 301 includes an information determiner configured to determine a usage scenario information of the extended reality device, a state determiner configured to determine the display state of the extended reality device according to the usage scenario information and at least one preset trigger reference condition, and a state information generator configured to generate the display state information according to the display state of the extended reality device.

Optionally, in some embodiments of this application, the state determiner includes a scenario sub-determiner configured to identify a scenario type corresponding to the usage scenario information and determine a target trigger reference condition from at least one preset trigger reference condition according to the scenario type, a factor sub-determiner configured to determine a display control reference factor according to the target trigger reference condition, wherein the display control reference factor comprises at least one of time, a location, a posture, a user manipulation, a power, a user emotion, or a program operating state, and a state sub-setter configured to determine a real-time reference information of the display control reference factor under the usage scenario information and set the information display condition to the display state of the extended reality device if the real-time reference information satisfies the target trigger reference condition.

Optionally, in some embodiments of this application, the second obtainer 302 includes an environment information obtainer configured to obtain an attribute information of a target user holding the extended reality device and an environmental scenario information where the target user is currently located, and a display information determiner configured to determine the information to be displayed according to the environmental scenario information and the attribute information.

Optionally, in some embodiments of this application, the displayer 303 includes a priority determiner configured to determine a display priority according to the attribute information and an information type of the information to be displayed, a depth information determiner configured to determine a display depth information of the information to be displayed according to the display priority, and a content displayer configured to present an extended reality content corresponding to the information to be displayed through the optical display module according to the display depth information.

Optionally, in some embodiments of this application, the content displayer includes a posture information sub-obtainer configured to obtain a posture information of the extended reality device, a position information sub-determiner configured to determine a display position information of the information to be displayed according to the posture information and the display priority, and a content sub-displayer configured to present the extended reality content corresponding to the information to be displayed through the optical display module according to the display depth information and the display position information.

Optionally, in some embodiments of this application, the content sub-displayer is further configured to determine a display style information of the information to be displayed according to the display priority and present the extended reality content corresponding to the information to be displayed through the optical display module according to the display depth information, the display position information, and the display style information.

Optionally, in some embodiments of this application, the content sub-displayer is further configured to capture a preview image through a camera of the extended reality device that previews a content through the optical display module, determine a background content information corresponding to the information to be displayed from the preview image according to the display position information, adjust an initial display style information of the information to be displayed according to a content tone of the background content information to obtain a target display style information, and present the extended reality content corresponding to the information to be displayed through the optical display module according to the display depth information, the display position information, and the target display style information.

Optionally, in some embodiments of this application, the display information determiner includes an intent sub-determiner configured to determine a behavioral intent of the target user according to the environmental scenario information and the attribute information, a first sub-setter configured to set a content information corresponding to the behavioral intent in a preset memory as the information to be displayed, and/or a second sub-setter configured to output the information to be displayed corresponding to the behavioral intent through an intent-content relationship model.

Optionally, in some embodiments of this application, the device further includes a display information obtainer, the display information obtainer includes a display information obtainer configured to obtain an original display information, and the second obtainer 302 includes a first sub-obtainer configured to set the original display information as the information to be displayed if the display state of the extended reality device represents that an information display condition is satisfied, or a second sub-obtainer configured to generate a display content control information and filter the information to be displayed from the original display information according to the display content control information if the display state of the extended reality device represents that the information display condition is satisfied.

In an embodiment of this application, the first obtainer 301 first obtains the display state information of the extended reality device, which indicates the display state of the extended reality device. Then, the second obtainer 302 obtains the information to be displayed if the display state indicates that the information display condition is met. Finally, the displayer 303 controls the optical display module of the extended reality device to display the extended reality content corresponding to the information to be displayed.

In an embodiment of this application, by obtaining the display state information of the extended reality device and using the display state indicated by this information to control the retrieval of information to be displayed and its subsequent display, the display state is used as a condition for displaying information. This approach allows precise control over the timing of content display on the extended reality device, avoiding indiscriminate and uncontrolled random displays, thereby enhancing a performance of the displayed information and improving a user experience.

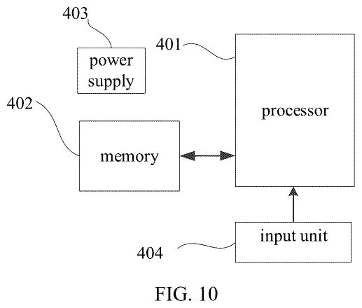

In addition, this application provides an electronic equipment, as shown in FIG. 10, which illustrates a schematic diagram of the structure of the electronic equipment involved in an embodiment of this application. Specifically:

The electronic equipment may include one or more processing cores in a processor 401, one or more computer-readable storage media in a memory 402, a power supply 403, and an input unit 404, among other components. It is understood by those skilled in the art that the structure of the electronic equipment shown in FIG. 10 does not limit the electronic equipment and may include more or fewer components than illustrated, combine certain components, or arrange the components differently. Specifically:

The processor 401 is a control center of the electronic equipment, connecting various parts of the electronic equipment through interfaces and circuits. By running or executing software programs and/or modules stored in the memory 402 and accessing data stored in the memory 402, the processor performs various functions and processes data to oversee the overall operation of the electronic equipment. Optionally, the processor 401 may include one or more processing cores. Preferably, the processor 401 may integrate an application processor and a modem processor, where the application processor primarily handles the operating system, user interface, and applications, while the modem processor primarily handles wireless communication. It should be noted that the modem processor may not necessarily be integrated into the processor 401.

The memory 402 is configured to store software programs and modules. The processor (401) runs the software programs and modules stored in the memory 402 to execute various functional applications and data processing tasks. The memory 402 may mainly include a program storage area and a data storage area. The program storage area can store the operating system and applications required for at least one function (e.g., audio playback, video playback, etc.), while the data storage area can store data created based on the use of the electronic equipment. Additionally, the memory 402 may include high-speed random access memory as well as non-volatile memory such as disk storage devices, flash memory, or other non-volatile solid-state storage devices. Correspondingly, the memory 402 may also include a memory controller to facilitate processor 401 access to the memory 402.

The electronic device also includes a power supply 403 that provides power to various components. Preferably, the power supply 403 can be logically connected to the processor 401 through a power management system, enabling functions such as charging, discharging, and power consumption management via the power management system. The power supply 403 may also include one or more direct current (DC) or alternating current (AC) power sources, rechargeable systems, power debugging circuits, power converters or inverters, power state indicators, and other components.

The electronic device may further include an input unit 404. The input unit 404 is used to receive input such as numerical or character information and to generate input signals related to user settings and functional control, including those from keyboards, mice, joysticks, optical devices, or trackballs.

Although not shown, the electronic device may also include a display unit, which is not elaborated here. Specifically, in this embodiment, the processor 401 of the electronic device executes the following instructions: it loads executable files corresponding to one or more application processes into the memory 402 and runs the applications stored in the memory 402. This enables the implementation of any of the steps in the extended reality content display control method provided in this application.

An embodiment of this application involves obtaining the display state information of the extended reality (XR) device. The display state information indicates the display state of the XR device. If the display state satisfies the information display conditions, the target display information is acquired, and the optical display module of the XR device is controlled to display the extended reality content corresponding to the target display information.

In this embodiment, by obtaining the display state information of the XR device and using this information to control the acquisition and display of target display information, the display state serves as a condition for displaying content on the XR device. This approach manages the timing of content display, avoiding unregulated and random content display on the XR device, thereby improving a performance of the displayed information and enhancing a user experience.

For specific implementations of the above operations, refer to the earlier embodiments, which will not be repeated here.

A person skilled in the art can understand that all or part of the steps in the methods described in the above embodiments can be executed via instructions or by controlling relevant hardware using instructions. These instructions can be stored on a computer-readable storage medium and loaded and executed by a processor.

To this end, an embodiment of this application provides a computer-readable storage medium that stores a computer program. The program can be loaded by a processor to execute any of the steps in the XR content display control method provided in an embodiment of this application.

The specific implementations of the above operations are described in the previous embodiments and will not be repeated here.

The computer-readable storage medium may include read-only memory (ROM), random-access memory (RAM), disks, optical discs, or other similar storage devices.

Since the instructions stored on the computer-readable storage medium can execute the steps in the XR content display control method provided in an embodiment of this application, they can achieve the beneficial effects of the methods described in an embodiment of this application. For details, refer to the previous embodiments, which will not be repeated here.

The detailed descriptions above have introduced an XR content display control method, device, electronic equipment, and computer-readable storage medium. Specific examples are used to explain the principles and implementations of the invention. The descriptions of the embodiments are intended to help understand the method and its core concepts. Meanwhile, for those skilled in the art, modifications may be made to specific implementations and application scopes based on the ideas of this invention. Therefore, the content of this specification should not be construed as a limitation of the invention.

It should be noted that, in the specific implementations of this application, the display state information, posture information, captured scene images, user attribute information, user scene information, user behavior intent information, power, usage time, user emotions, and other related data involved in the XR device require user consent or authorization when applied to specific products or technologies. Furthermore, the collection, use, and processing of such data must comply with the relevant laws, regulations, and standards of the applicable countries and regions.

What is claimed is:

1. A method for controlling an extended reality content display, applied to an extended reality device, comprising:
obtaining a display state information of the extended reality device, wherein the display state information indicates a display state of the extended reality device;
if the display state of the extended reality device represents that an information display condition is satisfied, obtaining an information to be displayed; and
controlling an optical display module of the extended reality device to display an extended reality content corresponding to the information to be displayed.

2. The method of claim 1, wherein obtaining the display state information of the extended reality device comprises:
determining a usage scenario information of the extended reality device;
determining the display state of the extended reality device according to the usage scenario information and at least one preset trigger reference condition; and
generating the display state information according to the display state of the extended reality device.

3. The method of to claim 2, wherein determining the display state of the extended reality device according to the usage scenario information and the preset trigger reference condition comprises:
identifying a scenario type corresponding to the usage scenario information and determining a target trigger reference condition from the at least one preset trigger reference condition according to the scenario type;
determining a display control reference factor according to the target trigger reference condition, wherein the display control reference factor comprises at least one of time, a location, a posture, a user manipulation, a power, a user emotion, or a program operating state; and
determining a real-time reference information of the display control reference factor under the usage scenario information, and setting the information display condition as the display state of the extended reality device if the real-time reference information meets the target trigger reference condition.

4. The method of claim 1, wherein obtaining the information to be displayed comprises:
obtaining an attribute information of a target user holding the extended reality device and an environmental scenario information of a current location of the target user; and
determining the information to be displayed according to the environmental scenario information and the attribute information.

5. The method of claim 4, wherein controlling the optical display module of the extended reality device to display the extended reality content corresponding to the information to be displayed comprises:
determining a display priority according to the attribute information and the information type corresponding to the information to be displayed;
determining a display depth information of the information to be displayed according to the display priority; and
presenting the extended reality content corresponding to the information to be displayed through the optical display module according to the display depth information.

6. The method of claim 5, wherein presenting the extended reality content corresponding to the information to be displayed through the optical display module according to the display depth information comprises:
obtaining a posture information of the extended reality device;
determining a display position information of the information to be displayed according to the posture information and the display priority; and
presenting the extended reality content corresponding to the information to be displayed through the optical display module according to the display depth information and the display position information.

7. The method of claim 6, wherein presenting the extended reality content corresponding to the information to be displayed through the optical display module according to the display depth information and the display position information comprises:
determining a display style information of the information to be displayed according to the display priority; and
presenting the extended reality content corresponding to the information to be displayed through the optical display module according to the display depth information, the display position information, and the display style information.

8. The method of claim 6, wherein presenting the extended reality content corresponding to the information to be displayed through the optical display module according to the display depth information and the display position information comprises:
capturing a preview image visible through the optical display module using a camera of the extended reality device;
determining a background content information corresponding to the information to be displayed from the preview image according to the display position information;
adjusting an initial display style information of the information to be displayed according to a content tone of the background content information to obtain a target display style information; and
presenting the extended reality content corresponding to the information to be displayed through the optical display module according to the display depth information, the display position information, and the target display style information.

9. The method of claim 4, wherein determining the information to be displayed according to the environmental scenario information and the attribute information comprises:
determining a behavioral intent of the target user according to the environmental scenario information and the attribute information;
setting a content information corresponding to the behavioral intent stored in a preset memory as the information to be displayed; and/or
outputting the information to be displayed corresponding to the behavioral intent through an intent-content relationship model.

10. The method of claim 1, wherein prior to obtaining the display state information of the extended reality device, the method further comprises:
obtaining an original display information;
if the display state of the extended reality device represents that information display condition is satisfied, obtaining the information to be displayed comprises:
setting the original display information as the information to be displayed if the display state of the extended reality device represents that the information display condition is satisfied; or
generating a display content control information and filtering the information to be displayed from the original display information according to the display content control information if the display state of the extended reality device represents that information display condition is satisfied.

11. A device for controlling an extended reality content display, applied to an extended reality device, the device comprising:
a first obtainer configured to obtain a display state information of the extended reality device, wherein the display state information indicates a display state of the extended reality device;
a second obtainer configured to obtain an information to be displayed if the display state of the extended reality device represents that an information display condition is satisfied; and
a displayer configured to control an optical display module of the extended reality device to display an extended reality content corresponding to the information to be displayed.

12. The device of claim 11, wherein the first obtainer comprises:
an information determiner configured to determine a usage scenario information of the extended reality device;
a state determiner configured to determine the display state of the extended reality device according to the usage scenario information and at least one preset trigger reference condition; and
a state information generator configured to generate the display state information according to the display state of the extended reality device.

13. The device of claim 12, wherein the state determiner comprises:
a scenario sub-determiner configured to identify a scenario type corresponding to the usage scenario information and determine a target trigger reference condition from at least one preset trigger reference condition based on the scenario type;
a factor sub-determiner configured to determine a display control reference factor according to the target trigger reference condition, wherein the display control reference factor comprises at least one of time, a location, a posture, a user manipulation, a power, a user emotion, or a program operating state; and
a state sub-setter configured to determine a real-time reference information of the display control reference factor under the usage scenario information and set the information display condition to the display state of the extended reality device if the real-time reference information satisfies the target trigger reference condition.

14. The device of claim 11, wherein the second obtainer comprises:
an environment information obtainer configured to obtain an attribute information of a target user holding the extended reality device and an environmental scenario information where the target user is currently located; and
a display information determiner configured to determine the information to be displayed according to the environmental scenario information and the attribute information.

15. The device of claim 14, wherein the displayer comprises:
a priority determiner configured to determine a display priority according to the attribute information and an information type of the information to be displayed;
a depth information determiner configured to determine a display depth information of the information to be displayed according to the display priority; and
a content displayer configured to present an extended reality content corresponding to the information to be displayed through the optical display module according to the display depth information.

16. The device of claim 15, wherein the content displayer comprises:
a posture information sub-obtainer configured to obtain a posture information of the extended reality device;
a position information sub-determiner configured to determine a display position information of the information to be displayed according to the posture information and the display priority; and
a content sub-displayer configured to present the extended reality content corresponding to the information to be displayed through the optical display module according to the display depth information and the display position information.

17. The device of claim 16, wherein the content sub-displayer is further configured to:
determine a display style information of the information to be displayed according to the display priority; and
present the extended reality content corresponding to the information to be displayed through the optical display module according to the display depth information, the display position information, and the display style information.

18. The device of claim 16, wherein the content sub-displayer is further configured to:
capture a preview image through a camera of the extended reality device that previews a content through the optical display module;
determine a background content information corresponding to the information to be displayed from the preview image according to the display position information;
adjust an initial display style information of the information to be displayed according to a content tone of the background content information to obtain a target display style information; and
present the extended reality content corresponding to the information to be displayed through the optical display module according to the display depth information, the display position information, and the target display style information.

19. The device of claim 14, wherein the display information determiner comprises:
an intent sub-determiner configured to determine a behavioral intent of the target user according to the environmental scenario information and the attribute information;
a first sub-setter configured to set a content information corresponding to the behavioral intent in a preset memory as the information to be displayed; and/or
a second sub-setter configured to output the information to be displayed corresponding to the behavioral intent through an intent-content relationship model.

20. The device of claim 11, further comprising a display information obtainer, wherein the display information obtainer comprises:
a display information obtainer configured to obtain an original display information;
wherein the second obtainer comprises:
a first sub-obtainer configured to set the original display information as the information to be displayed if the display state of the extended reality device represents that an information display condition is satisfied; or
a second sub-obtainer configured to generate a display content control information and filter the information to be displayed from the original display information according to the display content control information if the display state of the extended reality device represents that the information display condition is satisfied.
